(19) United States
(12) Patent Application Publication
(10) Pub. No.: US 2008/0148837 A1
(43) Pub. Date: Jun. 26, 2008

(54) Red fluorescent inks that change properties after being processed

(76) Inventors: Judith D. Auslander, Westport, CT (US); Richard A. Bernard, Norwalk, CT (US); Shunichi Higashiyama, Yokkaichi-shi (JP); Michiko Aoyama, Nagoya-shi (JP)

Correspondence Address: PITNEY BOWES INC.;35 WATERVIEW DRIVE, P.O. BOX 3000, MSC 26-22, SHELTON, CT, 06484-8000, US

(21) Appl. No.: 11/644,629

(22) Filed: Dec. 22, 2006

(51) Int. Cl. C09D 11/00; B41F 31/00; G01N 17/00

(52) U.S. Cl. 73/150 R; 101/491; 106/31.15

(57) ABSTRACT

Ink-jet inks and methods for security and anti counterfeiting utilities are described. The inks are fluorescent with a particular characterizing emission when illuminated with ultraviolet or other interrogating light and then fluoresce with a different characteristic upon illumination with bright light such as from a copying machine. The inks comprise a fluorescent dye, an aqueous liquid vehicle comprising water and organic solvents in sufficient amounts to achieve an ink viscosity and surface tension effective for application of the ink to a substrate in a predetermined pattern by ink-jet printing, wherein the inks are characterized in that after exposing under Xenon lamp of 3,150,000 J/m², the fluorescent strength of the ink diluted 100 times existing between about 500 nm and about 700 nm by excitation of ultraviolet radiation, decreases by at least about 50%. Desirably, the absorbance of the ink is between about 400 nm and about 600 nm and the ink loses fluorescence when subjected to ultraviolet radiation and/or visible radiation. The examples illustrate inks comprised of a dye selected from the group consisting of C.I. Acid Red 52, C.I. Acid Red 87, C.I. Acid Red 92 and C.I. Acid Red 1; water; and organic, polar solvent(s).

### CROSS REFERENCE TO RELATED APPLICATION

This application is related to a copending application of the same inventors filed on equal date, and entitled Red Fluorescent Inks for Bar Code Printing, Process And Printed Articles (Attorney Docket No. G-227), the disclosure of which is incorporated herein by reference.

### BACKGROUND

This invention relates to new red fluorescent inks and methods for security and anti counterfeiting utilities. The inks are fluorescent with a particular characterizing emission when illuminated with ultraviolet or other interrogating light and then fluoresce with a different characteristic upon illumination with bright light.

Security is becoming increasingly important as copying technology improves. Tickets, coupons, bank notes, bank checks, and other documents or articles that represent more than nominal value can be effectively reproduced more easily now than at any time before with high definition scanning and copying equipment. This advance in copying technology has placed the ability to make copies in the hands of masses of individuals who can make virtually unlimited numbers of copies without significant investment. This capability requires simple and low cost deterrent.

Many security techniques and devices have been proposed to provide at least some level of security. Unfortunately, many of these devices, such as holograms, special papers with coded threads or beads, and the like, are very costly and require sophisticated equipment to verify. The art has proposed the use of printed fluorescent and/or phosphorescent markings, which are helpful in many cases to identify a given document as an original, but a higher level of security would be desired in many cases.

When fluorescent markings are employed to mark an article for security, the article bearing the marking is typically printed in a colored or colorless ink that fluoresces upon illumination with ultraviolet light. The images can be printed with any type of printer, and the easily detected fluorescent marking can be copied by relatively unsophisticated copyists. It would be desirable to have marking technology that was simple to use by an authorized printer, but which would be beyond the capabilities of most amateurs.

Because the security markings, such as a ticket date or code should be readable with good definition visually as well as possess security features, high readability is essential for most applications. Good security can be augmented by high-density bar codes such as those known as 2D bar codes because they can provide the security marking with a particular code selected for the particular use. For example, a bar code might provide information as to a value limit or a specific value of an article. It might also contain information about the producer or the intended recipient. Bar codes can be read by machine to convey large amounts of information. It would be desirable to have inks that provided very high definition but would lose fluorescent intensity and definition if subjected to high intensity light for forensic purposes or to cancel some indicium of authenticity.

There is the further need to provide these security solutions by the technology of ink-jet printing, which print images by ejecting ink droplets form a cartridge onto a printing medium such as paper. In one method droplets are formed by electrostatically drawing ink by use of piezoelectric elements. In another, means heat ink to form gas bubbles and eject ink by pressure provided by the bubbles. Inks should be suitable for both types of printing without sacrificing high optical density (dark visible image), intense initial fluorescence, good visible red color or print sharpness, without clogging of the nozzle or taking excessive periods of time to dry.

There is a need for improved fluorescent inks and methods for printing security markings by ink-jet printing and utilizing them to detect copies which fail due to exposure to high intensity light, which inks must provide optically-dense red printed images of defined red color with initially high-intensity fluorescence emission that is diminished by specified illumination.

### SUMMARY

It is an object of invention to provide new security inks and methods.

It is a more specific object of the invention to provide new ink-jet printing inks that can provide printed images with initial high-intensity fluorescence emission that is diminished by bright light.

It is another object of the invention to provide inks that can be used to print images that can be inspected at a first level in normal daylight and then at another, such as with an ultraviolet lamp to evaluate authenticity.

It is yet another object of the invention to provide new fluorescent security inks for use in methods for ink-jet printing capable of printing images wherein the peak of fluorescent intensity of the printed images is within a range from about 500 nm to about 700 nm in wavelength when the ink is excited by 254 nm ultraviolet radiation.

It is still another object of the invention to provide new fluorescent security inks for ink-jet printing capable of printing sharp red images wherein the peak of fluorescent intensity of the diluted ink is more than about 70.

It is another object of the invention to provide new fluorescent security inks for ink-jet printing capable of printing visibly red images wherein the peak of absorbance of the ink, which is diluted by water by 100 times, was more than about 0.6.

It is another object of the invention to provide new fluorescent security inks in cartridges that protect the inks from premature decay in fluorescent intensity.

It is another object of the invention to provide new method for security such as forensic markers or cancellation using fluorescent inks that exhibit decreased fluorescence following exposure to bright light.

It is yet another and more specific object of the invention to provide new method for determining the authenticity of printed articles through the use of fluorescent security inks that exhibit decreased fluorescence following exposure to bright light.

These and other objects are accomplished by the invention, at least in its preferred aspects, which provides ink compositions, packages containing them, processes for using them and the resulting products.

The security inks of the invention are aqueous and capable of producing machine-readable markings exhibiting fluorescence when exposed to fluorescent-exciting radiation, but exhibit reduced fluorescence following exposure to bright light. The security inks are useful for printing by ink-jet printing and comprise a fluorescent dye, an aqueous liquid vehicle comprising water and organic solvents in sufficient amounts to achieve an ink viscosity and surface tension effective for application of the ink to a substrate in a predetermined pattern by ink-jet printing, wherein the inks are characterized in that after exposing under Xenon lamp of 3,150,000 J/m², the fluorescent strength of the ink diluted 100 times existing between about 500 nm and about 700 nm by excitation of ultraviolet radiation, decreases by at least about 50%. Desirably, the absorbance of the ink is between about 400 nm and about 600 nm and the ink loses fluorescence when subjected to ultraviolet radiation and/or visible radiation.

In preferred forms, the fluorescence intensity of 0.1 wt % dye solution used in making the inks is more than about 70 by excitation of ultraviolet radiation. Preferred security inks of the invention will comprise a dye is selected from the group consisting of C.I. Acid Red 52, C.I. Acid Red 87 and C.I. Acid Red 92, and the color of the ink which is diluted with water by 100 times and measured in 1 mm cell is L*: about 80±10, a*: about 45±20, b*: about 20±30.

In a preferred method, the fluorescence intensity existing between about 500 nm and about 700 nm by excitation of ultraviolet radiation, decreases to less than about 50% of its original value after exposing a 100% coated print made with the security ink of the invention which has about 5,400,000 pl/inch² ink volume, under Xenon lamp of 5,796,000 J/m².

In another aspect, the invention provides a packaged fluorescent ink for ink-jet printing as defined above, wherein the ink is stored in a container which is non-transmitting to visible radiation and/or ultraviolet radiation. Preferably, the storage container will be an ink-jet cartridge.

In yet another aspect, the invention provides a security method comprising: printing a portion of predetermined text and/or graphics on a substrate using ink capable of reading in visible light, and printing a second portion of text and/or graphics using an ink as defined above.

In yet another aspect, the invention provides a method of detecting copying, which comprises: obtaining an article having thereon an image printed with an ink as defined above, subjecting that image to ultraviolet light, determining the intensity of fluorescence of the emission from the image, comparing the intensity of the fluorescence to a reference value and, based on the comparison, determining if the image has been subjected to bright light.

A number of preferred aspects of the invention will be described below.

### BRIEF DESCRIPTION OF THE DRAWINGS

The invention will be better understood and its advantages will become more apparent from the following description, especially when read in light of the accompanying drawing, wherein:

FIG. 1 is a front elevation of a ticket showing printed matter with security features according to the invention;

FIG. 2 is a schematic perspective view of a print ink cartridge partially cut away to show the security ink of the invention; and

FIG. 3 is a flow diagram of a security system according to the present invention.

### DETAILED DESCRIPTION

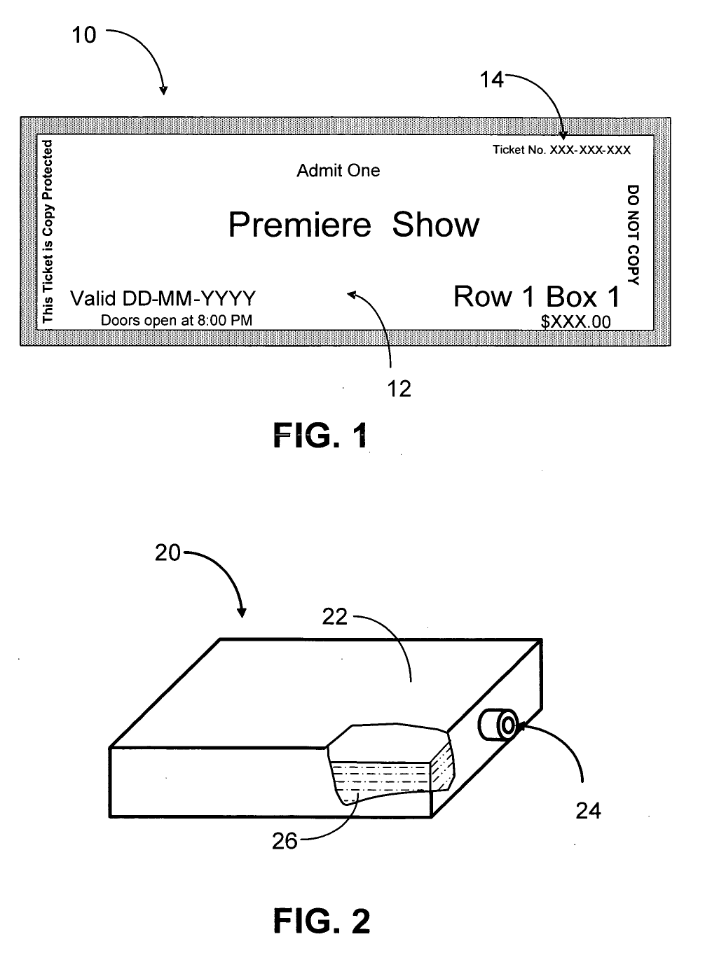

The invention relates to new security systems and inks which utilize images printed with fluorescent ink for security and anti-counterfeiting reasons. The term “image” as used herein is meant to include text, graphics, symbols and any other printed marking including bar codes. The invention is described with specific reference to an admission ticket 10, as in FIG. 1, but it will be apparent to the skilled worker that any document or article can be employed where the advantages of the invention will enhance security. While security inks have previously utilized a fluorescent property, these inks can be copied and duplicated and will remain for more than necessary time period, making misuse or abuse easier than desired. Advantageously, the inks and systems of the invention utilize photo-sensitive fluorescent dyes so that printed images are made unreadable upon exposure to intense light. The printed images can be detected after exposure, and reuse can be prevented or tracked. This can be a strong deterrent to unauthorized extensive copying or can be used as a desired method of cancellation.

The fluorescent security inks of the invention are particularly intended for use ink-jet printers, and are provided with certain physical properties, such as a certain viscosity and a specified surface tension, suitable for that use. The viscosity of the liquid inks used in current piezoelectric ink-jet printers is about 1.5 to about 20 centipoise (cps) and in the thermal ink-jet printer is lower (about 1 to about 5 cps). The desirable surface tension of liquid ink-jet printer inks should be between about 30 to about 45 dynes/cm. The formulations of the invention will comprise a fluorescent dye, an aqueous liquid vehicle comprising water and organic solvents in sufficient amounts to achieve an ink viscosity and surface tension effective for application of the ink to a substrate in a predetermined pattern by ink-jet printing. The pH of the inks will desirably be above about 7 and preferably fall within the range of from about 7.5 to about 9.0.

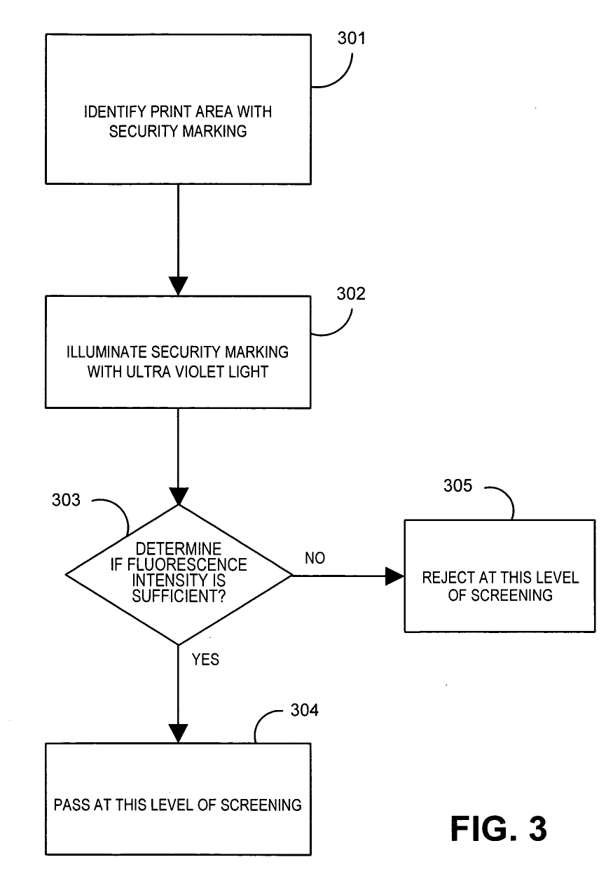

Before describing the inks in greater detail, we provide a brief description of their use in a preparing secure documents, such as a ticket 10 depicted in front elevation in FIG. 1. The drawing shows printed matter in both secure and nonsecure formats, with the secure areas of printing identified as 12 and 14. The other areas of printing can be with any ink and image. It is possible, for example, to print the images using more than one type of security ink to make copying more difficult and to check for authenticity if one image fails a screening test. The use of a valid date 12 in an ink according to the invention and a ticket number 14 is one way to authenticate a ticket manually, say by the time consuming process of checking a list of ticket numbers and checking other forms of identification if the fails ticket fails initial screening, one form of which is described in connection with FIG. 3.

The inks of the invention must be initially strongly fluorescent and then lose at least a significant portion of it upon exposure to strong visible or ultraviolet light. This makes it necessary to package the inks in opaque materials, e.g., at least one package which is non transmitting to ultraviolet and/or visible radiation. In a preferred aspect, as illustrated in FIG. 2, an ink-jet printer cartridge is schematically shown in perspective as a suitable package. The cartridge 20 is shown to include essential features of an outer wall 22 and an ink outlet 24. The construction of cartridges of this type is well known and there are many different types for a variety of uses, but the wall portion 22 should be made of a single or multiple layers which will have the necessary light blocking properties. The wall 22 is partially cut away to reveal the ink 26 inside.

Reference now to FIG. 3 will show one process for utilizing the inks of the invention in a security scheme. As a first step 301, the process calls for identifying the print area with the security marking. This can be done manually or automatically either before or after the next step 302 which calls for illuminating the security marking with ultra violet light. Lighting means are well known for this purpose and reference can be had to the examples below to guide the selection of commercially available means. The next step 303 calls for determining if fluorescence intensity is sufficient. Again, reference need only be made to the examples for guidance as to the proper commercial equipment. If the answer at this stage is yes, the document can pass this stage of screening 304. If it is not, the document will not pass this stage of screening 305. It will be seen that the invention provides an extremely simple and rapid means for providing an initial screening test, which can be followed by a more precise method where desired. It is easily used for quick checks of tickets by people standing in line or of objects, such as mail pieces, passing through automated scanning equipment.

The security inks of the invention are aqueous and capable of producing machine-readable markings exhibiting fluorescence when exposed to fluorescent-exciting radiation, but exhibit reduced fluorescence following exposure to bright light. The security inks are useful for printing by ink-jet printing and comprise a fluorescent dye, an aqueous liquid vehicle comprising water and organic solvents in sufficient amounts to achieve an ink viscosity and surface tension effective for application of the ink to a substrate in a predetermined pattern by ink-jet printing, wherein the inks are characterized in that after exposing under Xenon lamp of 3,150,000 J/m², the fluorescence intensity of the ink diluted 100 times existing between about 500 nm and about 700 nm by excitation of ultraviolet radiation, decreases by at least about 50%. Desirably, the absorbance of the ink is between about 400 nm and about 600 nm and the ink loses fluorescence when subjected to ultraviolet radiation and/or visible radiation. In a preferred form, the fluorescent strength existing between about 500 nm and about 700 nm by excitation of ultraviolet radiation, decreases to less than about 50% of its original value after exposing a 100% coated print made with the security ink of the invention which has about 5,400,000 pl/inch² ink volume, under Xenon lamp of 5,796,000 J/m². And, yet further, the optical density of a 100% coated print which has about 5,400,000 pl/inch² ink volume show, after exposing under Xenon lamp of 5,796,000 J/m², a decrease in fluorescence intensity equal to at least about 50% of its initial value.

In general the inks of the invention meet the criteria of having a peak of fluorescence of the ink exists between about 500 nm and about 700 nm by excitation of ultraviolet radiation. Also, the fluorescence intensity or strength of the ink diluted by about 100 times is more than about 70 by excitation of ultraviolet radiation, and the peak of absorbance exists between about 400 nm and about 600 nm, and the absorbance of the ink diluted by 100 times and measured in 1 mm cell is more than about 0.6. The examples below illustrate inks meeting the criteria of the invention that are comprised of a dye selected from the group consisting of C.I. Acid Red 52, C.I. Acid Red 87, C.I. Acid Red 92 and C.I. Basic Red 1; water; and organic, polar solvent(s). Auxiliary dyes can also be employed as long as they do not adversely affect the important properties of the inks. The examples below illustrate the use of C.I. Acid Yellow 73 in combination with C.I. Acid Red 52, C.I. Acid Red 87 and C.I. Acid Red 92.

The solvent system of these inks will typically comprise organic polar solvents and water. The organic polar solvents are all soluble in water. The solvent's polarity is a function of the solvating properties, which in turn is a measure of the sum of the molecular properties responsible for the interaction between the solute and solvent. The water used is preferably super pure, e.g., which means it is essentially free of impurities capable of causing the precipitation and the agglomeration of the ink, and causing nozzle clogging. The inks should also be essentially free of such impurities. Water will typically comprise a majority of the formulations, e.g., about 55 to about 90 weight percent, while the organic polar solvents will typically comprise up to about half of the solvent system, e.g., from about 10 to about 45 weight percent of the solvent system.

Organic solvent additives, particularly those referred to as glycol humectants, are useful because of their water absorbing hygroscopic properties namely. Among this group are ethylene glycol, propylene glycol, diethylene glycol, polyethylene glycol (PEG) and glycerin. Another category of useful humectants includes materials such as powerful surfactant humectants which prevent drying of the ink in ink-jet nozzles when exposed to air and an example is the Nuosperse® surfactant (e.g., ethoxylated oleyl alcohol, alkyl polyglycol, tridecyl alcohol ethoxylated, phosphated sodium salt). Another series of solvents were selected based upon a high dipole moment and high hydrogen bonding solubility parameters such as 2-pyrolidone, N-methyl pyrolidone, sulfolane, gamma butylactone, 4-methylmorpholine-n-oxide and dimethylsulfoxide. All these solvents are nonvolatile, polar and hygroscopic and dissolve in water causing an increase in viscosity. The glycol ether type solvents can be selected depending on the environment because they can act as a bridging agent with various polarity resins or other components and assume polar or non-polar nature depending upon the environment. The glycol ethers can increase penetration into paper substrates and also aids in fixing the ink to the paper thus improving water fastness. The examples of this type solvent are propylene glycol butyl ether, diethylene glycol butyl ether, diethylene glycol propyl ether, triethylene glycol ethyl ether and triethylene glycol mono-n-butyl ether.

It is a distinct advantage of the red inks of the invention that they not only display fluorescence, they exhibit a clearly red color. The color of the ink before printing is desirably red and printed images exhibit a hue fully consistent with that expected for red for such images. Desirably, the red inks (diluted 100 times with water per standard test protocol) of the invention have a color defined as red by colorimetric spectrometer (e.g., UV-3100PC produced by Shimadzu Corporation), i.e., L*=about 70 to about 90, a*=about 25 to about 65, b*=about −15 to about 55. Equally important, the printed images made from these inks will have a color defined as red by colorimetric spectrometer (e.g., SC-T produced by Suga Test Instrument Co., Ltd.), i.e., L*=about 55 to about 75, a*=about 45 to about 65, b*=about −15 to about 25. These results are according to CIE (International Commission on Illumination) standards established in 1964. The L* value is a measure of light and dark, while the a* and b* values are a measure of the color. Neutral color would be represented by a*=0 and b*=0, with the color shifting from gray to black as the L value decreases. Frequently, the formulation of red inks for use with ink-jet printing to provide fluorescent images do not retain the basic essential of good red color. The test protocol is described in the examples below, and generally involves the light source is halogen lamp or deuterium lamp, and the cell is quartz cell.

It is an advantage of the invention that the symbol contrast of 2-dimension image printed by 600 dot by 300 dot/inch² of printing density is between about 40% and about 100%, and the print growth value, x and y, of 2-dimension printed by 300 dot by 300 dot/inch² of printing density which the volume of 1 dot is about 30 pl, is between about −0.1 and about 0.26.

The following examples are presented to further illustrate and explain the invention and are not to be taken as limiting in any regard. Unless otherwise indicated, all parts and percentages are by weight.

### EXAMPLES

A series of inks were prepared according to the invention and tested to determine that they meet the criteria of the invention. The inks have the formulations indicated in the following Table 1:

TABLE 1
Composition of Inks

| | 1 | 2 | 3 | 4 |
|---|---|---|---|---|
| C.I. Acid Red 52 | 0.4 | — | — | — |
| C.I. Acid Red 87 | — | — | 3.5 | — |
| C.I. Acid Red 92 | — | 1.2 | — | — |
| C.I. Basic Red 1 | — | — | — | 1.0 |
| C.I. Acid Red 289 | — | — | — | — |
| C.I. Acid Yellow 73 | 1.5 | 0.8 | 0.2 | — |
| Super pure water | 68.1 | 68.0 | 66.3 | 69.0 |
| Polyethylene Glycol (M.W. 200) | 10.0 | 10.0 | 10.0 | 10.0 |
| 2-Pyrrolidone | 17.0 | 17.0 | 17.0 | 17.0 |
| Triethylene Glycol Mono Butyl Ether (BTG) | 3.0 | 3.0 | 3.0 | 3.0 |
| Total | 100.0 | 100.0 | 100.0 | 100.0 |

Each ink was diluted by water by 100 times for testing the properties of fluorescence, absorbance and color, with the results reported below in Table 2.

The fluorescence spectrum of each of the diluted ink was observed with a fluorescence spectrophotometer (F-4500 produced by Hitachi High-Technologies Corporation). The fluorescence spectrum was observed in range from 500 nm to 700 nm in wavelength. The wavelength of excitation light was 254 nm, and the fluorescence of the diluted ink was in a 1 mm-thick quartz cell.

A recording sample (print) was prepared with the non-diluted ink by ejecting the ink onto an envelope (Signet envelopes manufactured by UNISOURCE) with a multifunction device (MFC-5100J produced by Brother Industries, Ltd.). The diluted ink and the recording sample were both subjected to exposure test of the under Xenon lamp was carried out with a weather meter (SC750-WN produced by Suga Test Instrument Co., Ltd.). The power of the Xenon lamp was 35 W/m². The exposure test was of the ink carried out for 90,000 seconds. Therefore, the total energy emitted by Xenon lamp was 3,150,000 J/m². The absorbance of the diluted ink was measured with an ultraviolet-visible spectrometer (UV-3100PC produced by Shimadzu Corporation). The absorbance was measured in a range from 400 nm to 600 nm in wavelength and was measured while the diluted ink was in a 1 mm-thick quartz cell.

The absorbance of the diluted ink was measured with an ultraviolet-visible spectrometer (UV-3100PC produced by Shimadzu Corporation). The absorbance was measured in a range from 400 nm to 600 nm in wavelength. The ink was diluted by water by 100 times beforehand, and the absorbance of the ink was measured while the diluted ink was in a 1 mm-thick quartz cell. The fluorescent intensity and absorbance data for the diluted inks are summarized in Table 2.

TABLE 2
The fluorescent intensity and absorbance for diluted inks

| | | 1 | 2 | 3 | 4 |
|---|---|---|---|---|---|
| Fluorescence | Before | 136(583 nm) | 148(555 nm) | 178(541 nm) | 321(555 nm) |
| Intensity | exposure | | | | |
| | Non exposure | 129(95%) | 147(99%) | 164(92%) | 314(98%) |
| | After | 36(26%) | 3(2%) | 5(3%) | 153(48%) |
| | exposure | | | | |
| Absorbance | Before | 0.698(566 nm) | 0.951(539 nm) | 3.869(520 nm) | 1.311(526 nm) |
| | exposure | 2.362(489 nm) | 1.317(491 nm) | — | 1.165(501 nm)) |
| | Non exposure | 0.699(100%) | 0.953(100%) | 3.908(101%) | 1.317(100%) |
| | | 2.359(100%) | 1.289(98%) | — | 1.159(99%) |
| | After | 0.296(42%) | 0.023(2%) | 0.043(1%) | 0.588(45%) |
| | exposure | 0.255(11%) | 0.064(5%) | — | — |

The color of the diluted ink was measured with an ultraviolet-visible spectrometer (UV-3100PC produced by Shimadzu Corporation). The results of the color tests are summarized in Table 3. Here also, the diluted ink was held in a 1 mm-thick quartz cell.

TABLE 3
Color of Ink and Prints

| | | 1 | 2 | 3 | 4 |
|---|---|---|---|---|---|
| Color of ink | L* | 75.7 | 81.2 | 84.0 | 80.8 |
| diluted 100 times | a* | 29.2 | 41.0 | 44.3 | 58.9 |
| 1 mm cell | b* | 48.7 | 37.5 | 31.5 | −9.5 |
| Color of print | L* | 59.7 | 64.6 | 67.8 | 66.2 |
| | a* | 53.7 | 57.2 | 59.1 | 61.8 |
| | b* | 16.4 | 14.3 | 18.1 | −9.4 |

The optical density of the recording sample was measured with an optical densitometer (“400” produced by X-Rite, ortho filter). Non-diluted ink was ejected onto envelope (Signet envelopes manufactured by UNISOURCE) with a multifunction device (MFC-5100J produced by Brother Industries, Ltd.) to obtain the recording sample. The fluorescence intensity of the recording samples was measured with a fluorescence spectrophotometer (F-4500 produced by Hitachi High-Technologies Corporation). The fluorescence spectrum was observed in range from 500 nm to 700 nm in wavelength. The wavelength of excitation light was 254 nm. The exposure test of the recording sample was carried out for about 165,600 seconds. Therefore, the total energy emitted by Xenon lamp was about 5,790,000 J/m². The ink was diluted by water by 100 times beforehand, and the test was carried out. Non-diluted ink was ejected onto envelope (Signet envelopes manufactured by UNISOURCE) with a multifunction device (MFC-5100J produced by Brother Industries, Ltd.) to obtain the recording sample. The results of these tests are summarized in Table 4.

TABLE 4
Fluorescence Intensity and Optical Density of Prints

| | | 1 | 2 | 3 | 4 |
|---|---|---|---|---|---|
| Fluorescence | Before exposure | 347(598 nm) | 367(589 nm) | 165(564 nm) | 254(571 nm) |
| Intensity | Non exposure | 328(95%) | 358(98%) | 146(88%) | 236(93%) |
| | After exposure | 45(18%) | 23(6%) | 26(16%) | 97(38%) |
| Optical | Before exposure | 0.84 | 0.77 | 0.78 | 0.44 |
| Density | Non exposure | 0.83(99%) | 0.75(97%) | 0.78(100%) | 0.44(100%) |
| | After exposure | 0.12(14%) | 0.07(9%) | 0.08(10%) | 0.08(18%) |

The dyes used in preparing the inks were diluted to 0.1 wt. % strength and testes for fluorescence strength, with the results as shown in Table 5.

TABLE 5
Fluorescent Strength of dye solutions (0.1%)

| | |
|---|---|
| C.I. Acid Red 52 | 75.5 |
| C.I. Acid Red 87 | 128.7 |
| C.I. Acid Red 92 | 102.2 |
| C.I. Basic Red 1 | 112.4 |

The following conclusions can be drawn from the above examples:
After exposure under Xenon lamp, the fluorescent intensity of the ink diluted decreased to 50% or lower of that of the ink before the exposure.
After the exposure under Xenon lamp, the absorbance decreased to 50% or lower of that of the ink before the exposure.
The fluorescent intensity and the absorbance did not decrease so much when the ink and the recording sample was not exposed under the Xenon lamp.

The above description is intended to enable the person skilled in the art to practice the invention. It is not intended to detail all of the possible modifications and variations, which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

We claim:

1. A fluorescent security ink for printing security markings, comprising a fluorescent dye, an aqueous liquid vehicle comprising water and organic solvents in sufficient amounts to achieve an ink viscosity and surface tension effective for application of the ink to a substrate in a predetermined pattern by ink-jet printing: the ink being characterized in that after exposing under Xenon lamp of 3,150,000 J/m², the fluorescent strength of the ink diluted 100 times existing between 500 nm and 700 nm by excitation of ultraviolet radiation, decreases by at least 50%.

2. A fluorescent security ink according claim 1, wherein the absorbance of the ink is between 400 nm and 600 nm, the ink being characterized in that after exposing under Xenon lamp of 3,150,000 J/m², and the absorbance of the ink decreases by at least 50%.

3. A fluorescent security ink according claim 1, wherein the ink is stored in at least one container which is non-transmitting ultraviolet radiation.

4. A fluorescent security ink according claim 1, wherein the ink is stored in at least one container which is non-transmitting visible and ultraviolet radiation.

5. A fluorescent security ink according claim 1, wherein the fluorescent strength of 0.1 wt % dye solution is more than 70 by excitation of ultraviolet radiation.

6. A fluorescent security ink according claim 5, wherein the dye is selected from the group consisting of C.I. Acid Red 52, C.I. Acid Red 87 and C.I. Acid Red 92.

7. A fluorescent security ink according claim 1, wherein the color of the ink which is diluted with water by 100 times and measured in 1 mm cell is L*: 80±10, a*: 45±20, b*: 20±30.

8. A fluorescent security ink, comprising a fluorescent dye, an aqueous liquid vehicle comprising water and organic solvents in sufficient amounts to achieve an ink viscosity and surface tension effective for application of the ink to a substrate in a predetermined pattern by ink-jet printing, wherein: after exposing under Xenon lamp of 5,796,000 J/m², the fluorescent strength of the 100% coated print which has 5,400,000 pl/inch² ink volume, existing between 500 nm and 700 nm by excitation of ultraviolet radiation, decreases by at least 50%.

9. A fluorescent security ink according claim 8, wherein: after exposing under Xenon lamp of 5,796,000 J/m², the optical density of the 100% coated print which has 5,400,000 pl/inch2 ink volume, decreases by at least 50%.

10. A fluorescent security ink according claim 8, wherein the ink is stored in at least one container which is non-transmitting ultraviolet radiation.

11. A fluorescent security ink according claim 8, wherein the ink is stored in at least one container which is non-transmitting visible and ultraviolet radiation.

12. A fluorescent security ink according claim 8, wherein the fluorescent strength of 0.1 wt % dye solution is more than 70 by excitation of ultraviolet radiation.

13. A fluorescent security ink according claim 12, wherein the dye is selected from the group consisting of C.I. Acid Red 52, C.I. Acid Red 87 and C.I. Acid Red 92.

14. A fluorescent security ink according claim 8, wherein the color of the print is L*: 65±10, a*: 55±10, b*: 10±15.

15. A packaged fluorescent security ink according claim 1, wherein the ink is stored in at least one container which is non-transmitting to ultraviolet radiation.

16. A packaged fluorescent security ink according claim 15, wherein the ink is stored in at least one container which is non-transmitting to visible radiation.

17. A process for printing a secure image comprising:
printing a portion of predetermined image on a substrate using ink capable of reading in visible light, and
printing a second portion of the image using an ink as defined in claim 1

18. A method of detecting copying, which comprises:
obtaining an article having thereon an image printed with an ink as defined above, subjecting that image to ultraviolet light,
determining the intensity of fluorescence of the emission from the image, comparing the intensity of the fluorescence to a reference value
and, based on the comparison, determining if the image has been subjected to bright light.
